(19) United States
(12) Patent Application Publication
(10) Pub. No.: US 2010/0198655 A1
(43) Pub. Date: Aug. 5, 2010

(54) ADVERTISING TRIGGERS BASED ON INTERNET TRENDS

(75) Inventors: Russell K. Ketchum, Newport Beach, CA (US); Eugene C. Nistor, Laguna Niguel, CA (US); James L. Wogulis, Laguna Beach, CA (US); Ruth A. Doane, Irvine, CA (US); Mark Scheele, Laguna Hills, CA (US); Neil C. Rhodes, Redlands, CA (US); Robert D. Gardner, Irvine, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 12/365,867

(22) Filed: Feb. 4, 2009

(51) Int. Cl. G06Q 30/00; G06Q 10/00; G06Q 40/00; G06F 17/30

(52) U.S. Cl. 705/10; 705/37; 707/E17.108; 705/39

(57) ABSTRACT

Among other things, a computer-implemented method for presenting an ad. The method includes receiving from an advertiser a predetermined level of online interest in a specified topic. The method further includes determining whether a current level of online interest meets or exceeds the predetermined level, and selectively presenting the ad based on the determination.

### TECHNICAL FIELD

This specification relates to event-driven ad placement.

### BACKGROUND

A key objective for advertisers is increasing the efficiency and effectiveness of ad campaigns. The efficiency of the ad campaign can be improved, among other things, by real time reporting and copy splitting. Methods and systems are needed to improve the effectiveness of the ad campaigns.

### SUMMARY

This specification describes methods and systems for advertising based on internet trends.

In one aspect, a computer-implemented method for presenting an ad is described. The method includes receiving from an advertiser a predetermined level of online interest in a specified topic. Subsequently, a determination is made whether a current level of online interest meets or exceeds the predetermined level. Based on the determination, the ad is selectively presented.

Further implementations can optionally include the following features. The ad may be presented if the current level of online interest meets or exceeds the predetermined level, otherwise no ad or a substitute ad may be presented. The level of online interest (that can be expressed in terms of an Internet trend) includes a count of keyword searches in the specified topic that have been entered in a web search interface during a time increment. The level of online interest can also be a running average of the counts taken over a plurality of time increments. Furthermore, the count of keyword searches can be segregated by a geographical region and/or a sub-region based on an origin of the keyword searches.

In another implementation, the specified topic can include more than one term. Additionally, the predetermined level of online interest in the specified topic can be set to a level that is constant in time. Alternatively, the predetermined level of online interest in the specified topic can also be a change in level over a predetermined time (a rate of online interest) or a change in level between the current level and a predicted level over a predetermined time.

In yet another implementation, the predetermined level of online interest in the specified topic can be a relative change between levels of online interest regarding two aspects of the specified topic. Alternatively, the predetermined level of online interest in the specified topic can be a relative change between the level regarding a first aspect and an offset to the level regarding a second aspect. In some implementations, the predetermined level of online interest in a specified topic can be established based on examination of historical levels of online interest in the specified topic. Optionally, the historical levels of online interest in the specific topic can be segregated by geographical regions and/or sub-regions. Geography-specific (or market specific) predetermined levels may be established based on the foregoing segregation.

Further implementations can optionally include the following features. The ad may be presented based on a current balance of a monetary fund (provided by the advertiser) exceeding a minimum cost for presenting the ad.

Additionally, the method can be implemented to cause an over-the-air, cable, satellite or internet radio content provider to broadcast the ad. Alternatively, the ad can be posted on a web site, billboard, or in print media.

In another aspect, a server for scheduling an ad includes a computerized electronic device configured to receive from an advertiser a predetermined level of online interest in a specified topic. The computerized electronic device is also configured to determine whether a current level of online interest meets or exceeds the predetermined level and to selectively schedule the ad based on the determination.

In yet another aspect, a computer-implemented method for bidding for unsold ad spots is described. The method includes establishing a predetermined level of online interest in a specified topic. A notification of an unsold ad spot is received from a broker. The method further includes determining whether a current level of online interest meets or exceeds the predetermined level, and selectively bidding for the received unsold ad spot based on to the determination.

In another aspect, a computerized electronic device is configured to establish a predetermined level of online interest in a specified topic. The computerized electronic device is also configured to receive from a broker a notification of an unsold ad spot. Furthermore, the computerized electronic device is configured to determine whether a current level of online interest meets or exceeds the predetermined level, and to selectively bid for the received unsold ad spot based on to the determination.

The subject matter described in this document potentially can provide various advantages. For example, an advertiser can define a rule to present a specific ad when internet search volume on a specified topic (in a particular market) exceeds a particular threshold. This allows an advertiser to concentrate spending to the periods when the ad is most relevant. The foregoing procedures can help campaign managers in determining more precisely when to start advertising in specific markets to increase the effectiveness of the ad campaign. Thus, consumers who are most interested in the advertised product can be reached during peak interest.

The subject matter described in this specification can be implemented as a method or as a system or using computer program products, tangibly embodied in information carriers, such as a CD-ROM, a DVD-ROM, a HD-DVD-ROM, a Blue-Ray drive, a computer memory, and a hard disk. Such computer program products may cause a data processing apparatus to conduct one or more operations described in this specification.

In addition, the subject matter described in this specification can also be implemented as a system including a processor and a memory coupled to the processor. The memory may encode one or more programs that cause the processor to perform one or more of the method acts described in this specification. Further the subject matter described in this specification can be implemented using various data processing machines.

Other features, objects, and advantages of the subject matter of this specification will be apparent from the description and drawings, and from the claims.

### DESCRIPTION OF DRAWINGS

FIG. 1 illustrates an exemplary implementation of advertising based on internet trends.

FIG. 2 is a schematic of an exemplary system configured to present advertisements based on internet trends.

FIG. 3 shows an exemplary method for presenting ads based on internet trends.

FIGS. 4-5 shows exemplary implementations of advertising triggered in response to internet trends.

FIGS. 6-7 shows other exemplary implementations of advertising triggered in response to online interest.

FIG. 8 shows another exemplary method for presenting ads based on internet trends.

FIG. 9 is a schematic diagram of a computerized electronic device.

### DETAILED DESCRIPTION

The systems and methods described in this document enable an advertiser to deliver highly effective ads, for example radio ads. Other advertising media may be TV and print. The radio and TV ad broadcast may be over the air or over the internet. Ads may also be posted on billboards, magazines and newspapers, in their tangible form or online. One exemplary advantage of the methods disclosed here is that advertisers can direct ad campaigns based on internet trends (activity) on and around a specified topic. Internet trends illustrate levels of online interest in the specified topic as a function of time. Therefore, the internet trends ultimately express a time evolution of consumer interest in products or services related to the specified topic.

This document describes systems and methods for specifying the conditions under which an ad is presented based on general online activity. For example, an advertiser indicates that a radio ad can be played, in a given market, if a web search volume (query-count) for a particular term or groupings of terms exceeds a predefined threshold. Advertisers can specify that certain ad campaigns participate in an auction (and/or buy ad spots) only in markets where special events are triggered. In a preferred implementation, data from Google Trends can be used for event targeting and triggering. Google Trends shows the number of keyword-based inquiries using the Google web search interface. Therefore, the internet trend for a specific subject tends to be a good proxy for estimating the interest that people have in that subject. The foregoing approach can be used by advertisers to determine: (1) the trend for searches related to an advertised product, and (2) the relative trend of the advertised product compared to a baseline. The baseline can be established, for example, in terms of the competition or the general market for the advertised product. Ad campaigns can react to changes in these trends.

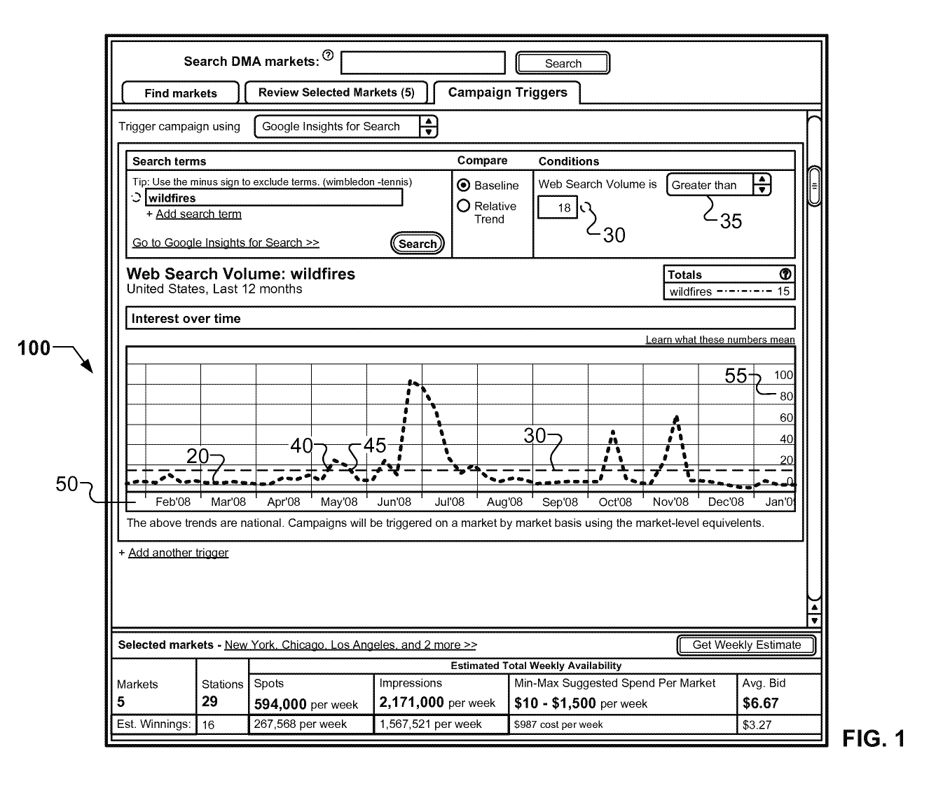

In an exemplary implementation illustrated in FIG. 1, a user interface 100 is configured to allow an advertiser to enter one or more keywords. For example, advertisers advertise fire insurance in Southern California from May through October during the fire season. If an advertising campaign is set up as a block of time from May to September, the advertiser spends money uniformly during that entire period. A more effective way to spend advertising money is to present the ad when a particular event of interest occurs. It will be shown below that an advertiser can define a rule to broadcast a specific ad when search volume in a particular market (for example based on Google Insights for Search) exceeds a particular threshold. This allows an advertiser to concentrate spending to the periods when the ad is most relevant.

In this document, the term internet trend represents an online interest in a specified topic over time, or equivalently a time series of the online interest in the specified topic. The terms online interest and level of online interest are used interchangeably. Online interest in a specified topic is defined as the relative (or normalized) search volume returned by a search engine, in the same fashion the search volume data is returned by, for example, Google Insights for Search. The search volume is defined as a count (or total number) of times a keyword (or synonym of the keyword) has been entered/queried in a search engine during a time increment. The time increment can be of order minutes, hours, days, etc. The count of keyword-queries during the latest time increment is referred to as the current level of online interest. In a preferred aspect, the search engine is the Google search engine although data from other search engines could be used.

Returning to FIG. 1, for example, the time series 20 represents the internet trend or the level of online interest in wildfires during the previous year. There are monthly divisions on the time axis 50, but the time increment is 1-day, i.e., a count of wildfire-queries is taken at the end of each day. The y-axis 55 represents the normalized daily count of “wildfires”-queries, i.e., the y-axis range is 0-100. In an alternative implementation, the level of online interest can be presented as a running average of the count of keyword-queries. The running average can be calculated over a preset number of time increments, for example a 5-day running average, 50-day running average, etc.

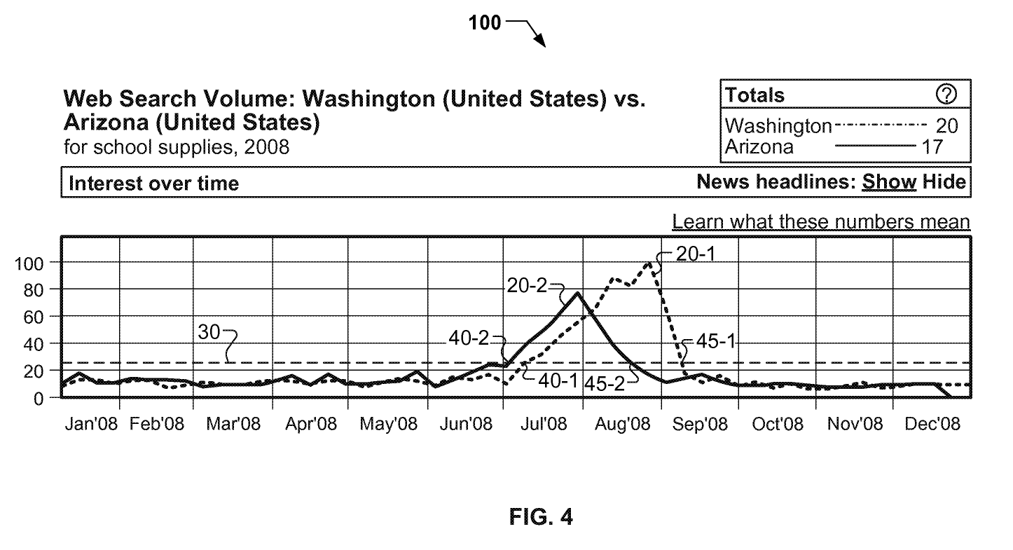

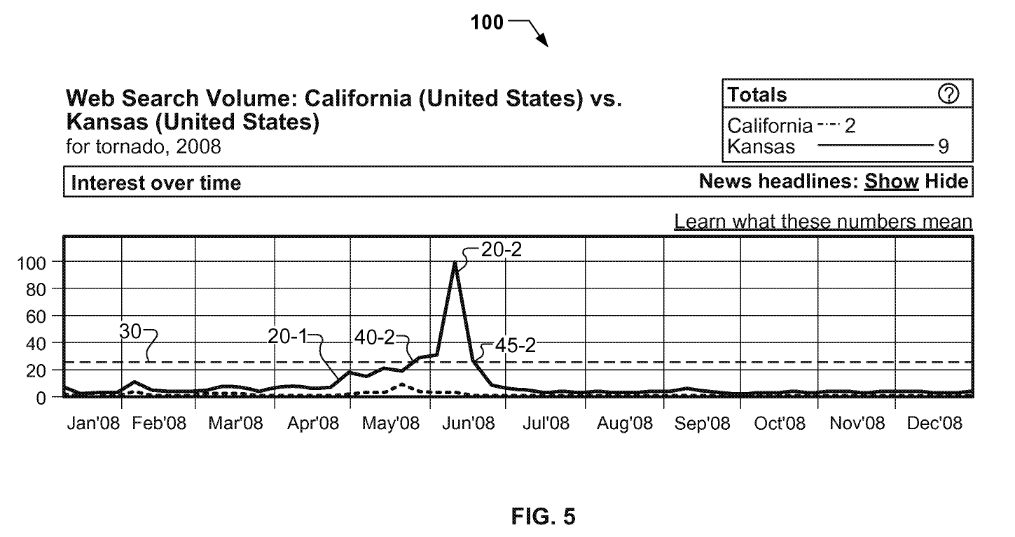

The “wildfires” internet trend can be used by a fire insurance provider to effectively target ad campaigns. The advertiser can define a threshold 30 either as a function of a baseline (“Baseline”) or of one of the entered terms (“Relevant Trend”). In FIG. 1 the threshold is a predetermined level of online interest equal to 18 (normalized value). The advertiser may request to present the ad if the search volume of the topic “wildfires” 20 is greater than or equal to the threshold 30 (based on user selection 35). Previously, an ad offering fire insurance was presented starting in early May (40), when the level of online interest in wildfires 20 became larger than the predetermined level of online interest 30. The condition for running the ad remained true until late May (45), when the level of online interest in wildfires 20 became less than the predetermined level of online interest 30. In accordance with the foregoing procedure and the threshold 30 illustrated in FIG. 1, the fire insurance ad was presented for a total number of 6 different time periods during the prior 12-month period. Notably, the advertiser did not spend money continuously during the “actuarial fire season” (from May through October), instead money was spent only during the periods of highest consumer interest in wildfires, and presumably highest fire insurance interest. It will be described below in reference to FIGS. 4-5 that the internet trends can be limited to (or segregated into) internet trends based on queries originated from geographical areas selected by the advertiser.

An advertiser can adopt a procedure for ad rotation based on alternating an ad and a substitute ad on a daily or weekly basis. In another aspect, the ad-triggering procedure based on internet trends and described in reference to FIG. 1 can be adapted to determine the best ad to play on behalf of the advertiser if an ad campaign includes multiple ads. For example, during times of high online interest in wildfires consumers may be at home guarding their property, but during times corresponding to low online interest in wildfires consumers whom are outdoors enthusiasts may be riding all-terrain vehicles (ATV) in the back-country. Therefore, referring again to FIG. 1, at time 45 the fire insurance ad was replaced with a substitute ad for ATV insurance. Accordingly, an ad offering fire insurance was presented when the level of online interest in wildfires 20 became larger that the predetermined level of online interest 30, and a substitute ad for ATV insurance was presented when the level of online interest in wildfires 20 became less than the predetermined level of online interest 30.

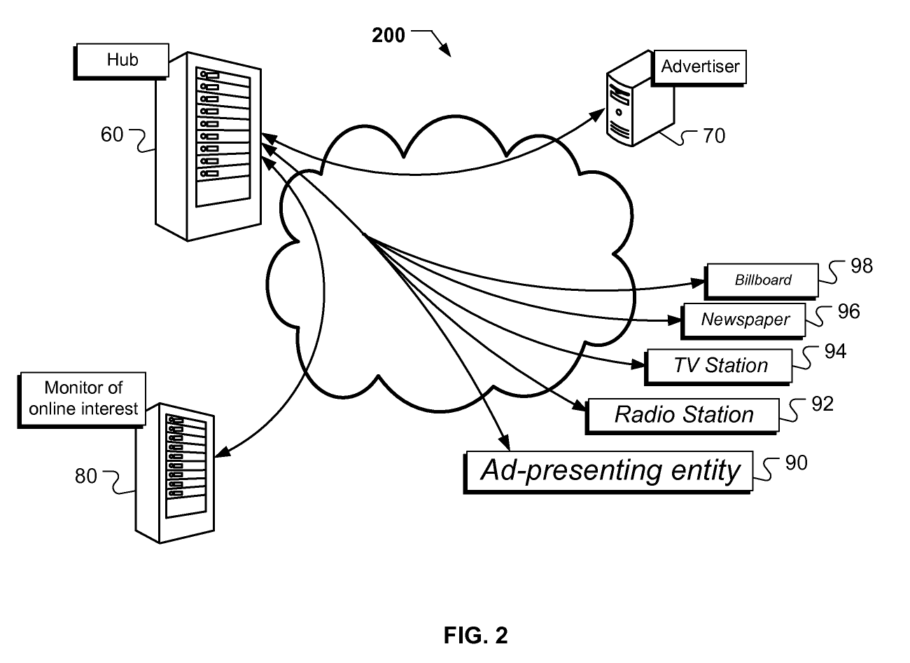

FIG. 2 is a schematic representation of a system for implementing advertising based on internet trends. A hub 60 is communicatively coupled via a network (represented by the cloud) with an advertiser 70 and a monitor of online interest (or internet trends) 80. The network can be the internet, a local area network or a wide area network. The hub 60 is also communicatively coupled to one or more of an ad-presenting entity 90, a radio station 92, a TV station 94, a newspaper 96 and a billboard 98.

The hub 60 includes a computerized electronic device configured to provide the interface 100 discussed in reference to FIG. 1. The interface 100 can be provided locally at the hub 60. In another aspect, the interface 100 can also be presented as a web service by a server at the hub 60, and may be accessible remotely, via the network, from the advertiser 70 or any of the ad-presenting entities 90-98. An advertiser 70 uses the interface 100 to input one or more ads to be presented by one of the ad-presenting entities 90-98. Additionally, the advertiser 70 also inputs a specified topic to monitor the internet trend relative to a predetermined threshold. The threshold is also provided by the advertiser 70. The internet trends on the specified topic are procured by the hub 60 from the monitor of online interest 80.

The monitor of online interest 80 can be an internet-based service provider including a plurality of computerized electronic devices. In a preferred implementation, the monitor of online interest 80 is Google (Google Insights for Search or Google Trends).

The advertiser 70 includes a computerized electronic device configured to remotely access (via the network) the interface 100 presented at the hub 60. The computerized electronic device of the advertiser 70 is configured to run a browser. The advertiser 70 also includes a store for storing ads, creatives, campaigns as electronic files or links. The ad, creative and campaign files or links can be transferred to the hub 60 prior to the start of or during an ad campaign.

The generic ad-presenting entity 90, the radio station 92, the TV station 94, the newspaper 96 and the billboard 98 each include a respective computerized electronic device configured to receive from the hub 60 the ad to be presented. The ad-presenting entities 90-98 are further operated to present the received ad based on instructions, a schedule, etc. transmitted by the hub 60.

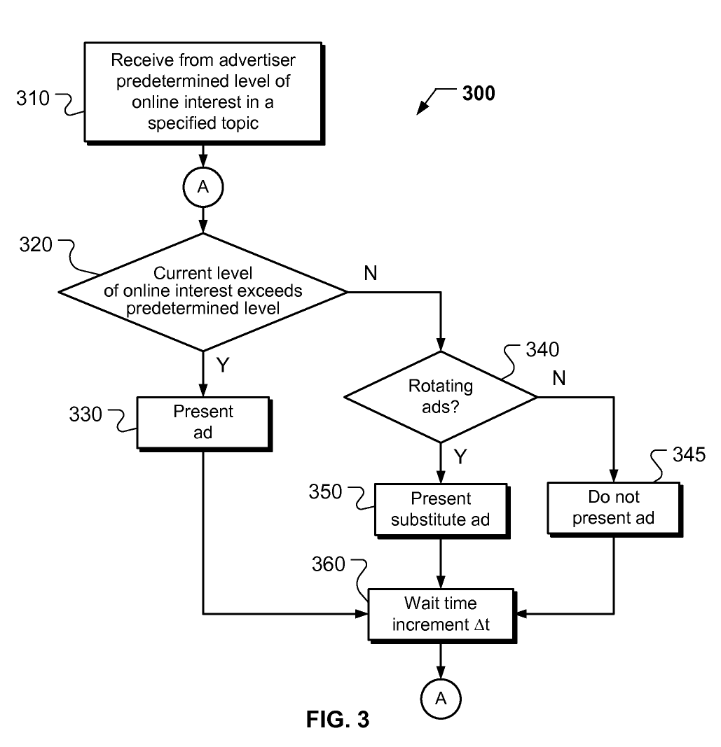

FIG. 3 illustrates an exemplary method 300 for advertising based on internet trends. The method 300 can be implemented within the advertising system 200 and further performed at the hub 60.

At step 310, the hub 60 receives from the advertiser 70 a predetermined level of online interest 30 in a specified topic 20. The advertiser 70 can enter input parameters to the interface 100 provided by the hub 60 via the network.

The specified topic 20 is selected (entered) by the advertiser. The specified topic 20 can be an advertised product. For example, an advertiser may trigger the presentation of Product X ads in response to the current level of online interest in Product X. The specified topic 20 can also be a term other than the product (for example, “wildfires”).

Furthermore, the specific topic 20 can be an action, condition or event caused by the advertised product. For example, an advertiser may trigger the presentation of MP3 player ads in response to the current level of online interest in sale of MP3s. Additionally, the specific topic 20 can be an action, condition or event prevented by the advertised product or service. For example, an advertiser may trigger the presentation of gym membership ads in response to the current level of online interest in obesity. In one embodiment, an advertiser can select a group of terms relating to a specific topic and specify that one, some all, or an average exceed the specified amount or percentage.

The predetermined level of online interest 30 can be of different types and can have different values. The type and value of the predetermined level of online interest 30 is selected by the advertiser. The predetermined level of online interest 30 can be a threshold that is constant over time. For example, the predetermined level of online interest 30 in wildfires illustrated in FIG. 1 is 18 on a scale of 0 to 100.

The predetermined level of online interest 30 can be a selected change in the level of online interest over a predetermined time, or equivalently a selected rate of the level of online interest. For example, the predetermined level of online interest 30 in wildfires illustrated in FIG. 1 may be a weekly rate of 5%/week. In this example, the weekly slope of the internet trend in wildfires that triggers the presentation of fire insurance ads is 5%. Notably, if the predetermined period of time is chosen to be the time increment (1 day), then the rate of the level of online interest is equivalent to a first derivative (or slope) of the internet trend.

The predetermined level of online interest 30 can be a selected change in the rate of the level of online interest over a predetermined time, or equivalently a selected rate of the rate of the level of online interest. For example, the predetermined level of online interest 30 in wildfires illustrated in FIG. 1 may be a week-over-week change in the weekly slope of 0.2%/week/week. In this example, the week-over-week change in the weekly slope of the wildfires internet trend that triggers the presentation of fire insurance ads is 0.2%. Specifically, if the weekly rate two weeks ago was 3%/week, and if the weekly rate last week was 3.4%/week, the change in the weekly rate of 0.4%/week that happened over a week will trigger the presentation of fire insurance ads. Notably, if the predetermined period of time is chosen to be the time increment (1 day), then the rate of the rate of the level of online interest is equivalent to a second derivative (or curvature) of the internet trend.

Returning to FIG. 3, at step 320, the hub determines whether a current level of online interest 20 meets or exceeds the predetermined level 30. If the current level of online interest in the specified topic 20 meets or exceeds the predetermined level the hub presents the ad (including placing the ad into an auction to be placed). If the current level of online interest in the specified topic 20 does not meet the predetermined level, the hub does not present the ad (including no placing the ad into an auction to be placed).

If the determination at step 320 is positive, then at step 330, the hub presents the ad. In general, when this document mentions placing an ad or not placing an ad, such placement can include placing or not placing an ad into an auction for placement. If the positive determination occurred for the first time (as was the case in FIG. 1, in early May 40), then the hub 60 transmits the ad for presentation to one of the ad-presenting entities 90-98. Alternatively, hub 60 instructs the ad-presenting entities 90-98, that are currently storing the ad, to present the ad for the first time, or to continue to present the ad.

At step 360, the hub 60 waits for a predetermined time increment before looping back to determine whether the current level of online interest in the specified topic meets or exceeds the predetermined level. In the meantime, the ad-presenting entities 90-98 are presenting the ad.

If the determination at step 320 is not positive, then at step 340, the hub determines whether an alternative or substitute ad is available. When no substitute ad is available, the hub does not present the ad as part of step 345. If the ad was being presented by the ad-presenting entities 90-98 when the determination at step 320 was taken (as was the case in FIG. 1, in late May 45), then the hub 60 instructs the ad-presenting entities 90-98 to stop presenting the ad. If the ad was not being presented by the ad-presenting entities 90-98 when the determination at step 320 was taken, then the hub 60 omits placing the ad.

At step 360, the hub 60 waits for a predetermined time increment before looping back to determine whether the current level of online interest in the specified topic meets or exceeds the predetermined level. In the meantime, the ad-presenting entities 90-98 are not presenting the ad.

If the determination at step 340 is positive, then at step 350, the hub presents the substitute ad. If the positive determination occurred for the first time, then the hub 60 transmits the substitute ad for presentation to one of the ad-presenting entities 90-98. Alternatively, hub 60 instructs the ad-presenting entities 90-98, that are currently storing the substitute ad, to either continue to present the substitute ad, or to replace the currently presented ad with the substitute ad.

At step 360, the hub 60 waits for a predetermined time increment before looping back to determine whether the current level of online interest in the specified topic meets or exceeds the predetermined level. In the meantime, the ad-presenting entities 90-98 are presenting the substitute ad.

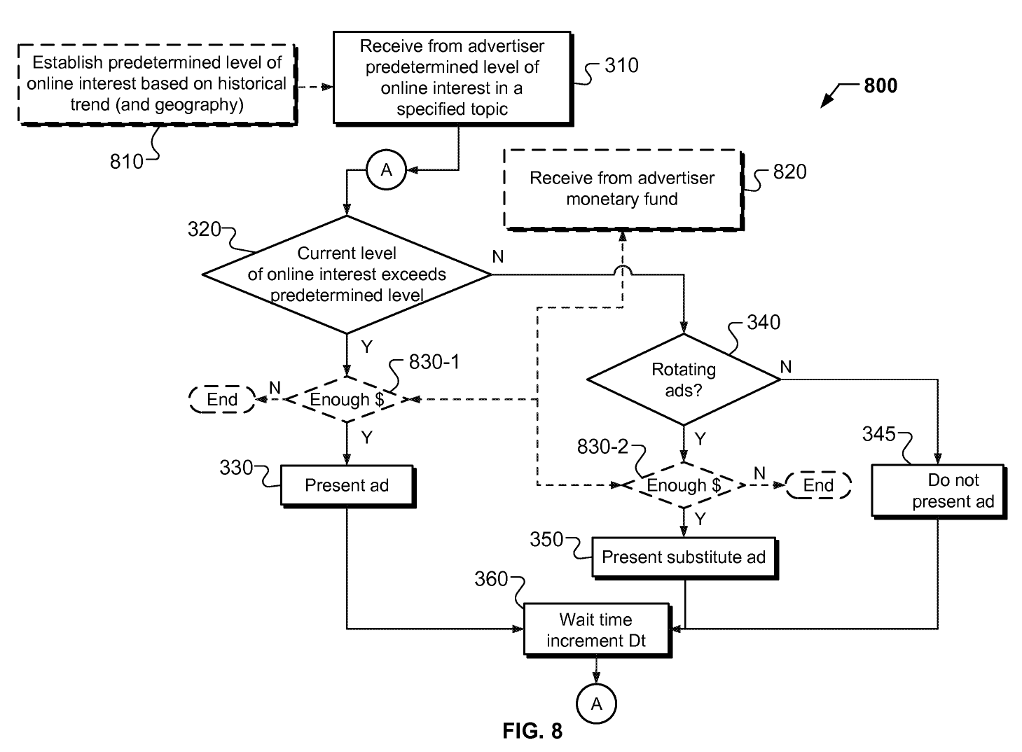

Several exemplary implementations of method 300 are illustrated in FIGS. 4-7. Additionally, method 300 can be integrated with other procedures performed by the hub 60. An exemplary implementation of such integration is presented in reference to FIG. 8.

FIG. 4 shows an exemplary implementation of method 300, where the specified topic is school supplies 20-1, 20-2. Internet trends 20 on school supplies displayed in interface 100 can be used by a first advertiser to trigger presenting a first ad related to school supplies. The same internet trends 20 on school supplies can be used by a second advertiser to trigger presenting a second ad related to after-school child care. In the implementation illustrated in FIG. 4, the time series of the online interest in school supplies is segregated in two internet trends: A first internet trend 20-1 illustrates online interest in school supplies based on queries originated in Washington State, while a second internet trend 20-2 illustrates online interest in school supplies based on queries originated in Arizona.

An advertiser for a national department store can set a predetermined level of online interest 30 to trigger presentation of a school supplies ad. The predetermined level illustrated in FIG. 4 has a value of 20 (normalized on a scale from 0 to 100.) Using method 300, the advertiser can avoid presenting the ad continuously during July through September, the traditional “back to school” period of time. Furthermore, the advertiser can present the ad only during peak online interest in school supplies (above the threshold 30), separately in Washington 20-1 (from 40-1 to 45-1 on the time scale) and Arizona 20-2 (from 40-2 to 45-2 on the time scale). For example, the advertiser stops presenting the ad in Arizona in mid-August 45-2 (when the online interest 20-2 drops below the threshold 30) and saves advertising money. In the meantime, the ad is being presented in Washington for three more weeks (from 45-2 to 45-1), because the online interest in Washington continues to exceed the predetermined level 30.

In another aspect, the count of keyword-queries can be segregated into and grouped by two or more geographical regions. In yet another aspect, the count of keyword-queries can be segregated into and grouped by two or more geographical regions and sub-regions. A geographical region (sub-region) can represent a designated market area (DMA). The level of online interest in a specified topic or event, such as “school supplies” in FIG. 5, reflects the level of interest that people in certain (geographic) markets have for the specific topic or event. As illustrated in the cases of Washington and Arizona, people in different markets react to an event (beginning of the school year) at different times compared to people in other markets. The foregoing findings can help campaign managers in determining more precisely when to start advertising in specific markets to increase the effectiveness of the ad campaign. Thus, consumers who are most interested in the advertised product can be reached during peak interest.

FIG. 5 shows an exemplary implementation of method 300, where the specified topic is tornados 20. Internet trends 20 on tornados displayed in interface 100 can be used by an insurance provider to trigger presentation of a home insurance ad. A first internet trend 20-1 illustrates online interest in tornados based on queries originated in California, and a second internet trend 20-2 illustrates online interest in tornados based on queries originated in Kansas.

The predetermined level 30 illustrated in FIG. 5 has a value of 20 (normalized on a scale from 0 to 100.) Again, using method 300, the advertiser can avoid presenting the ad during the entire tornado season from April through October. Furthermore, the advertiser can present the ad only during peak online interest in tornados (above the threshold 30), separately for California 20-1 and Kansas 20-2 (from 40-2 to 45-2 on the time scale). According to the internet trends on tornados 20-1 and 20-2 there are a few weeks when people were extremely interested in tornados in Kansas, but the interest in California was never significant. Advertisers who sell home insurance can focus on their best customer base if they advertise insurance during the weeks of May and June in Kansas. Notably, the online interest in California did not reach the predetermined level 30 throughout the prior 12-month period, thus the advertiser avoids advertising in California altogether and saves significant advertising money in the meantime.

According to the exemplary implementation of method 300 illustrated in FIGS. 4 and 5, relative differences between internet trends in two states can provide an advertiser with useful ad triggering means. In another implementation, internet trends for more than two states, for example for the entire US, can be used by an advertiser to decide whether an ad campaign should be pursued or not in each specific market. National-level internet trends on a specified topic may not correctly infer the consumer interest for each regional market. Alternatively, market-level trends are based on multiple thresholds that are selected, respectively, for each individual market. More characteristics of the national and regional approaches to trend-based advertising are considered below.

Internet trend granularity at market level can be used by an advertiser to set respectively accurate threshold values. For national ad campaigns, the national-level trend can be extrapolated to individual market-level trends. For example, the US-trend graph (national level) for a “Product X” campaign may have a threshold value of 80 (normalized between 0-100). Alternatively, in California, a corresponding threshold value can be, for example, 68, while in Minnesota the corresponding threshold value can be 25. The ad campaign may trigger when the current levels of online interest for “Product X” in California and Minnesota go above, respectively, 68 and 25.

The implementations of method 300 illustrated in FIGS. 1, 4 and 5 use either (1.a) one internet trend (query on relevant keywords for the campaign) or (1.b) two internet trends (a first query for the campaign and a second query for the baseline), (2) a “threshold” parameter, and (3) a “direction” parameter.

(1.a) The threshold can be a predetermined level in the internet trend. A campaign may trigger when the values of the internet trend go above or below the threshold, in the direction indicated by the “direction” parameter. For example, a campaign can set up a query for “snow tires”, a threshold of 50 and a direction of “up”. When the internet trends goes above 50 (normalized between 0-100), the event triggers and the campaign participates in the auction. The campaign stops when the value decreases below 50.

(1.b) The threshold can also be a difference between the two queries in the second case. A campaign can trigger when the values of the queries go above or below the threshold, as indicated by the “direction” parameter. In another example, a campaign can set up a query for “Product X”, a comparison query for “Product Y”, a threshold of 0 and a direction of “down”. The campaign participates in the auction while the level of online interest for “Product X” is below the level of online interest for “Product Y” in a given market.

The “threshold” parameter can be specified either as a constant value or a constant change in a moving average. The constant threshold can be specified in terms of a date at which the threshold was set, and in terms of the internet trend used to set the threshold (i.e., the internet trend including the specific topic and time interval). For example, the threshold may be set to the value 80 based on an internet trend over the last year. Alternatively, the moving average is defined by how long in the past the average is calculated. For example, the threshold may be set to trigger whenever the moving average for the last 30 days increases by 15%.

In yet another aspect, forecasted data can be used in conjunction with internet trends to trigger ad campaigns. The advertiser may decide to use past internet trends or to use future projections. Because the advertiser cares about a future event, a forecast (projection, extrapolation) of the level of online interest in the event may be compared to a current level of interest to trigger the ad campaign.

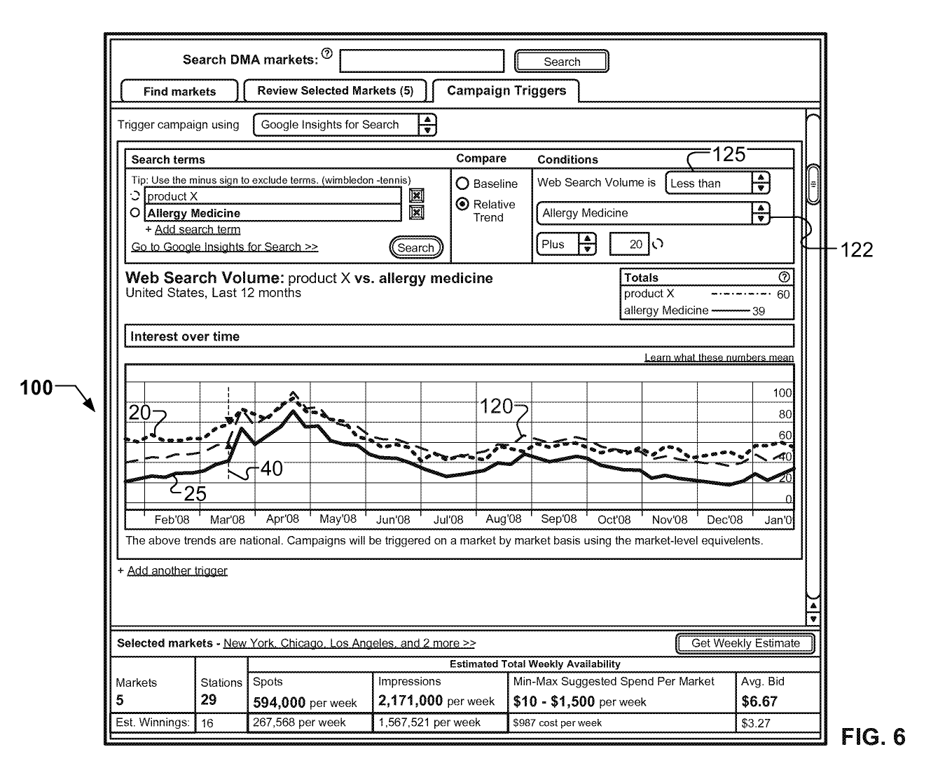

FIG. 6 shows an exemplary implementation of method 300, where the specified topic is Product X 20. In this example, Product X is an allergy relieving product, and the internet trend on Product X 20 is displayed in interface 100 alongside the internet trend on the generic term “allergy medicine” 25. An advertiser can set a predetermined level of online interest 120 to trigger presentation of an ad for Product X. The predetermined level 120 illustrated in FIG. 6 is set in terms of a relative difference between the level of online interest in Product X 20 and the level of online interest of allergy medicine 25 (or relative trend). Using method 300, the advertiser can present the ad only when the current relative internet trend is less than (125) a predetermined level 120. The relative “direction” 122 in this example is measured from the allergy medicine trend 25. Additionally, a bias of 20 can be used to provide the value of the predetermined threshold 120.

In FIG. 6, the difference between the Product X trend 20 and the allergy medicine trend 25 is larger than the offset value of 20 starting from the beginning of the year until mid-March 40. During this period of time, the ad for Product X is not being presented. Once the difference between the Product X trend 20 and the allergy medicine trend 25 becomes less than the offset value of 20, the hub 60 can present the ad for Product X. The foregoing condition is satisfied for the remainder of the year. Therefore the ad-presenting entities 90-98 present the ad for Product X starting from mid-March 40 on.

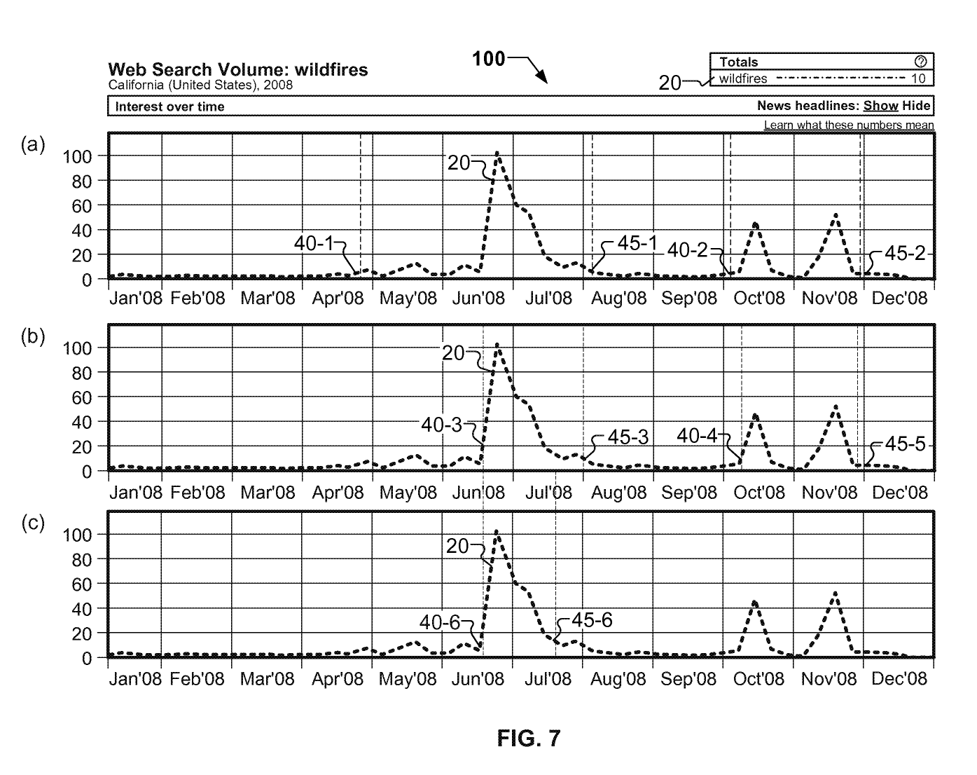

FIG. 7 shows an exemplary implementation of method 300, where the specified topic is once again wildfires 20, as in FIG. 1. In FIG. 7, an advertiser is interested in presenting the fire insurance ad during periods of peak online interest in wildfires 20. Peaks can be determined based on different degrees of peak finding sensitivity. For example in FIG. 7(a), the peak finding algorithm is adjusted to a very high sensitivity level, such that multiple (most) peaks of the internet trend on wildfires 20 are being captured. Therefore, the ad is presented during peak periods (each peak period starting at 40 and ending at 50). FIG. 7(b) illustrates advertising windows established by a similar peak-finding algorithm adjusted to an intermediate sensitivity level. And FIG. 7(c) shows advertising windows established by a similar peak-finding algorithm adjusted to a low sensitivity level.

FIG. 8 illustrates additional features of method 300 and shows an exemplary integration of method 300 with other procedures performed by the hub 60. For example, at step 810, the advertiser accesses the interface 100 provided by the hub and examines historical levels of online interest in the specified topic 20. For example, using historical internet trends as illustrated in FIGS. 1, 4-7, the user can establish accurate thresholds. The predetermined level of online interest in tornados discussed earlier is set to a value of 20 based on examining the historical internet trend in FIG. 5. A threshold lower than 20 may inadvertently capture pre-tornado season “chatter” of less interest to the advertiser. Additionally, a threshold lower than 20 may inadvertently capture “noise” that originates in California and is related to tornados. The later noise is also not of interest to the advertiser.

At step 820, the hub receives from the advertiser an advertising budget and access to a monetary fund. The monetary fund is supposed to cover the cost of presenting an ad during the ad campaign based on numerous criteria, such as the number of times the ad is presented, the duration per instance, time of the day, market, etc. (See application incorporated by reference.) The balance of the ad campaign is checked at multiple times and the ad may be presented during an available slot only if the monetary fund balance can cover the cost of presenting the ad during the available slot.

Conditional steps 830-1 and 830-2 are performed to determine whether the balance in the account can cover the cost of presenting the desired instance of the ad. The monetary balance verification steps are performed after the step 320, when the determination based on the current level of online interest in a specified topic is performed. Therefore, if the current level of online interest in the specified topic 20 meets or exceeds the predetermined level 30 the hub 60 performs conditional step 830-1 before presenting the ad. When not enough money is left in the monetary fund to cover for the cost of presenting the desired instance of the ad, the ad is not being presented. If the monetary fund balance can cover the cost of the open ad slot, then the ad is being presented as discussed in FIG. 3.

The methods and system described in this document can also be used for auction campaigns, in contrast to (and not for) reservation campaigns. In an exemplary implementation, an ad broker communicates to the advertiser that an ad spot has become available. In case of an ad campaign running in reservation mode, the newly available spot is automatically assigned to the advertiser. Alternatively, in case of an ad campaign running in auction mode, the system first verifies the current level of online interest in the specified topic. If the current level of online interest meets or exceeds the predetermined level set up by the advertiser, then the system automatically bids for the newly available ad spot.

Otherwise, if the current level of online interest does not meet the predetermined level, then no bidding takes place at that time. However, if after a preset time increment, when the system determines that the current level of online interest does meet or exceed the predetermined level, the system places a bid if the ad spot is still available.

Exemplary Elements of Software Infrastructure:

The UI includes mechanisms for capturing the targeting queries and the thresholds to define a feed. The UI transmits the request of a new feed and proposed start and end dates to the FeedService. The end date is used so the feeds are not collected if they are not needed. The start date is used by the FeedService to get the required feeds by that time.

The FeedService is configured to have a “TRENDS” feed category. The feed type can be specific to each ad campaign. Therefore, the feed registers with the FeedService prior to the beginning of the ad campaign.

The feed parameters can be one or more of:

Trends query: A trends query can be a full query or can be a broken down query in the form of a list of keywords and categories. The trends query uses a date range for the data retrieved.

Baseline trends query: A baseline query has the same characteristics as the regular trends query.

Fixed threshold value: A fixed threshold value can be in the range of 0 to 100. The fixed threshold value can be internally translated into a fixed value based on the query. The fixed threshold value can be expressed as a percentage.

Feed direction: A feed direction can be one of “up” and “down”.

Moving average percent: A moving average percent requires (i) a duration of how long i n the past to look at, and (ii) a change value expressed in percentage.

Examples of feed expressions:

At registration time:

TRENDS:feedId=1223,query=“keywords=Product
X,category=automotive”,query_start=01/01/2008,query_end=
01/01/2009”,baseline_query=“category=
automotive”, moving_average_length=30days,
expiration_date=03/15/2009

At query time:

TRENDS:feedId=1223(MARKET=_PRIMARY_DMA_MARKET_{—} and
DATE=_TODAY_{—} and THRESHOLD=80 and DIRECTION=“up”)
or
TRENDS:feedId=1223(MARKET=_PRIMARY_DMA_MARKET_and
DATE=_TODAY_{—} and MOVING_AVERAGE_PERCENT=15 and DIRECTION=“up”)
or
TRENDS:feedId=1223(MARKET=_PRIMARY_DMA_MARKET_and
DATE=_TODAY_{—} and BASELINE_DIFERENCE_PERCENT=10 and
DIRECTION=“down”)
or
TRENDS:feedId=1223(MARKET=_PRIMARY_DMA_MARKET_{—} and
DATE=_TODAY_{—} and FORECAST_DIFERENCE_PERCENT=10 and
DIRECTION=“down”).

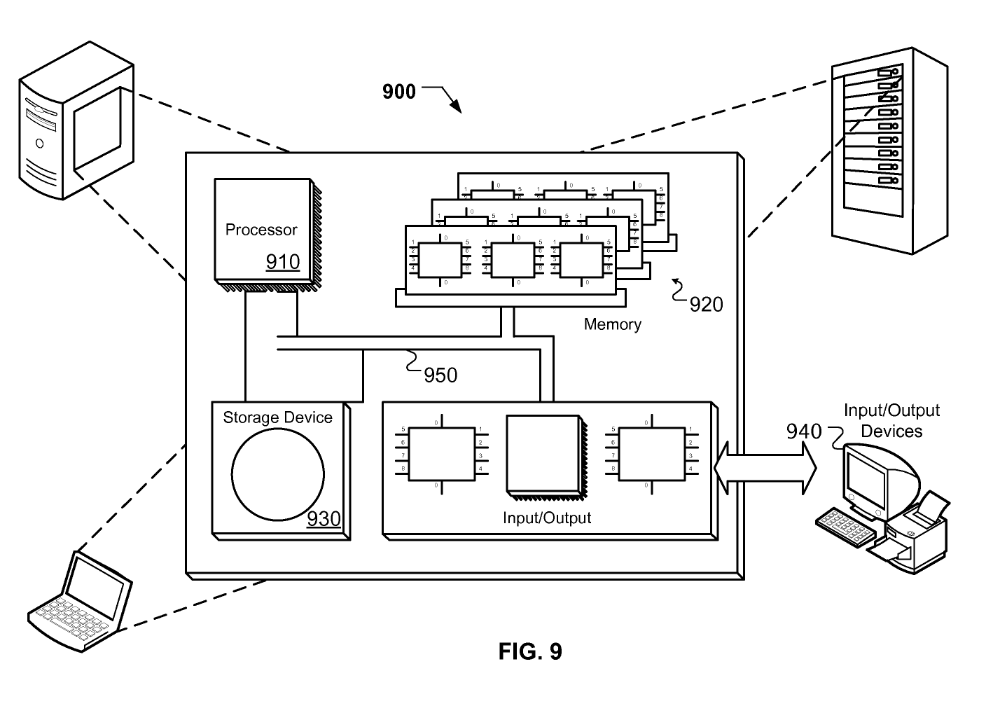

FIG. 9 is a schematic diagram of a computer system 900 representing any computerized electronic device included in the hub 60, the advertiser 70, the monitor of online interest 80, and the ad-presenting entities 90, 92, 94, 96 and 98. Also the computer system 900 can represent a server at the annotation information repository 50. The system 900 can be used for the operations described in association with any of the computer-implement methods described previously, according to one implementation. The system 900 is intended to include various forms of digital computers, such as laptops, desktops, workstations, personal digital assistants, servers, blade servers, mainframes, and other appropriate computers. The system 900 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 900 includes a processor 910, a memory 920, a storage device 930, and an input/output device 940. Each of the components 910, 920, 930, and 940 are interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 may be a floppy disk device, a hard disk device, an optical disk device, or a tape device.

The input/output device 940 provides input/output operations for the system 900. In one implementation, the input/output device 940 includes a keyboard and/or pointing device. In another implementation, the input/output device 940 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or a web server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations of advertising triggers based on internet trends have been described. Nevertheless, it will be understood that various modifications may be made without departing from the spirit and scope of the subject matter of this specification. For example, triggers that are not based on internet trends may be used. Such other sources to trigger presentation of an ad may be predetermined weather conditions, air quality and other environmental characteristics. Other examples of triggers used for ad campaigns are RSS Feeds, Song Feed, number of visits (hits) on a webpage, etc.

Accordingly, other embodiments are within the scope of the following claims.

What is claimed is:

1. A computer-implemented method for presenting an ad, the method comprising:
receiving from an advertiser a predetermined level of online interest in a specified topic;
determining whether a current level of online interest meets or exceeds the predetermined level; and
selectively presenting the ad based on the determination.

2. The method of claim 1, further comprises:
presenting the ad if the current level of online interest meets or exceeds the predetermined level;
otherwise not presenting the ad.

3. The method of claim 1, further comprises:
presenting the ad if the current level of online interest meets or exceeds the predetermined level;
otherwise presenting a substitute ad.

4. The method of claim 1, wherein the level of online interest comprises:
a count of keyword searches in the specified topic that have been entered in a web search interface during a time increment.

5. The method of claim 4, wherein the level of online interest further comprises:
a running average of the counts taken over a plurality of time increments.

6. The method of claim 4, wherein the count of keyword searches is segregated by one or more of geographical region and sub-region based on an origin of the keyword searches.

7. The method of claim 1, wherein the specified topic includes more than one terms.

8. The method of claim 1, wherein the predetermined level of online interest in the specified topic comprises a first level.

9. The method of claim 1, wherein the predetermined level of online interest in the specified topic comprises a first change in level over a predetermined time.

10. The method of claim 9, wherein the predetermined level of online interest in the specified topic comprises a second change in level between the current level and a predicted level over a predetermined time.

11. The method of claim 1, wherein the predetermined level of online interest in the specified topic comprises a first change of level-rate over a predetermined time.

12. The method of claim 1, wherein the predetermined level of online interest in the specified topic comprises a relative change between levels of online interest regarding two aspects of the specified topic.

13. The method of claim 10, wherein the predetermined level of online interest in the specified topic comprises a relative change between the level regarding a first aspect and an offset to the level regarding a second aspect.

14. The method of claim 1, further comprising:
examining historical levels of online interest in a specified topic; and
establishing a predetermined level based on the examination.

15. The method of claim 12 further comprising:
segregating the historical levels of online interest in the specific topic by one or both geographical regions and sub-regions; and
establishing geography-specific predetermined levels based on the segregation.

16. The method of claim 1, further comprising:
receiving from the advertiser a monetary fund; and
presenting the ad if a current balance of the monetary fund exceeds a minimum cost for presenting the ad.

17. The method of claim 1, wherein presenting the ad comprises causing an over-the-air, cable, satellite or internet radio content provider to broadcast the ad.

18. The method of claim 1, wherein presenting the ad comprises causing a web site, billboard, print media (station or play point) to post the ad.

19. A server for scheduling an ad, the server comprising:
a computerized electronic device configured to:
receive from an advertiser a predetermined level of online interest in a specified topic;
determine whether a current level of online interest meets or exceeds the predetermined level; and
selectively schedule the ad based on the determination.

20. A computer-implemented method for bidding for unsold ad spots, the method comprising:
establishing a predetermined level of online interest in a specified topic;
receiving from a broker a notification of an unsold ad spot;
determining whether a current level of online interest meets or exceeds the predetermined level; and
selectively bidding for the received unsold ad spot based on to the determination.

21. A computerized electronic device configured to:
establish a predetermined level of online interest in a specified topic;
receive from a broker a notification of an unsold ad spot;
determine whether a current level of online interest meets or exceeds the predetermined level; and
selectively bid for the received unsold ad spot based on to the determination.
